(19) United States
(12) Patent Application Publication
(10) Pub. No.: US 2008/0252598 A1
(43) Pub. Date: Oct. 16, 2008

(54) REMOTE CONTROLLER AND MULTIMEDIA EDUCATION SYSTEM USING SAME

(75) Inventors: CHUN-HUI FAN, Tu-Cheng (TW); SHIH-FANG WONG, Tu-Cheng (TW); TSUNG-JEN CHUANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/962,112

(22) Filed: Dec. 21, 2007

(30) Foreign Application Priority Data
Apr. 10, 2007 (TW) 96112581

(51) Int. Cl. G06F 3/033

(52) U.S. Cl. 345/157

(57) ABSTRACT

A remote controller includes a sensor, a first processor, and a transmitter. The sensor is used for sensing movements of the remote controller, and generating corresponding sensed signals. The first processor is for processing the sensed signals and generating movement signals. The transmitter is used for transmitting the movement signals to help a computer to control movements of a cursor thereof. A multimedia education system using the remote controller is also provided.

### BACKGROUND

1. Field of the Invention

The present invention generally relates to multimedia education systems, and more particularly to a remote controller and a multimedia education system using a remote control.

2. Description of Related Art

In the past, blackboards and chalks were necessary tools used by teachers to educate students. Nowadays, with the development of computers, multimedia technologies are widely used in education. In a multimedia education system, computers are used for audio, video, text, image, animation, and so on. Therefore, students can obtain knowledge visually and easily using the multimedia education system.

Referring to FIG. 3, a conventional multimedia education system 100 is used by a user. The multimedia education system 100 includes a screen 10, a projector 20, a computer 30, and a laser pen 50. The computer 30 transmits signals carrying video information to the projector 20, and the projector 20 receives the signals and projects the video information onto the screen 10. The laser pen 50 is used to project a laser beam onto the screen 10 to form a laser point, in order to point out the content that the user wants to explain. However, the user often needs an assistant to operate the computer, such as to change the video information, and this is an inconvenience.

Therefore, improvements for a remote controller and a multimedia education system are needed in the industry to address the aforementioned deficiency.

### SUMMARY

A remote controller includes a sensor, a first processor, and a transmitter. The sensor is used for sensing movements of the remote controller, and generating corresponding sensed signals. The first processor is for processing the sensed signals and generating movement signals. The transmitter is used for transmitting the movement signals to a computer to control movements of a cursor thereof. A multimedia education system using the remote controller is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic, block diagram showing a multimedia education system in accordance with a first exemplary embodiment.

FIG. 2 is a schematic, block diagram showing a multimedia education system in accordance with a second exemplary embodiment.

FIG. 3 is a schematic diagram showing a conventional multimedia education system.

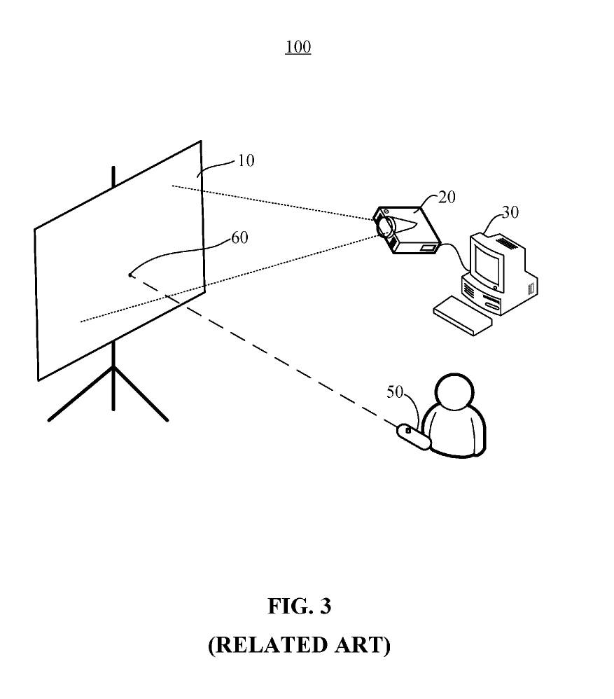

### DETAILED DESCRIPTION OF THE EMBODIMENTS

Reference will now be made to the drawings to describe a preferred embodiment of the present remote controller and a preferred embodiment of the present multimedia education system.

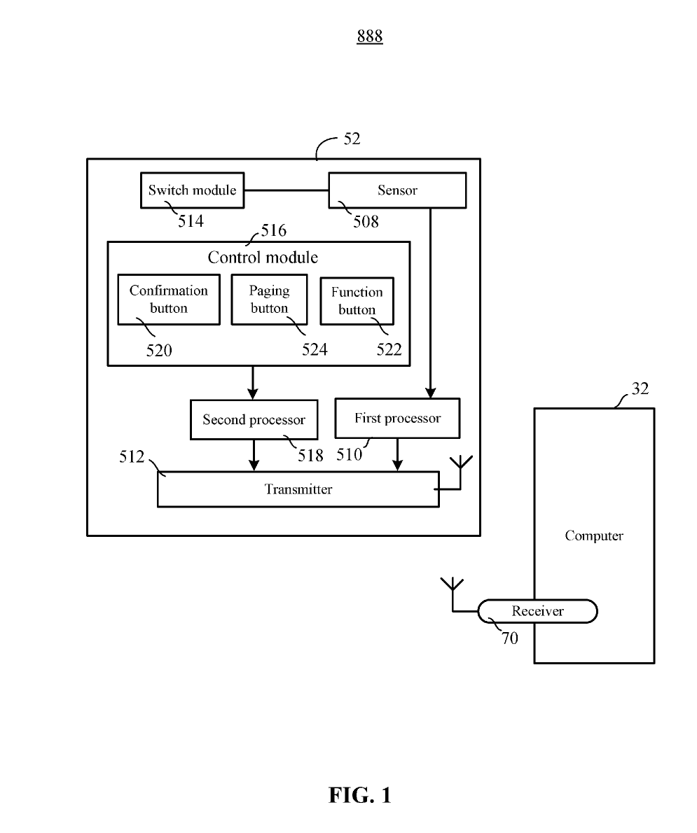

Referring to FIG. 1, a multimedia education system 999 in accordance with a first exemplary embodiment includes a computer 32, a remote controller 52, and other devices (not shown) such as a screen, a projector, and so on. The remote controller 52 can be used by a user to control movements of a cursor of the computer 32. The movements of the cursor can be displayed on the screen through the projector.

The remote controller 52 includes a sensor 508, a first processor 510, a transmitter 512, a switch module 514, a control module 516, and a second processor 518. The sensor 508 is used for sensing movements of the remote controller 52, and generating corresponding sensed signals. The sensor 508 can be an accelerator sensor or a gyroscope. The first processor 510 is used for processing the sensed signals and generating movement signals. The transmitter 512 is used for transmitting the movement signals to the computer 32.

The switch module 514 is used for powering up or powering down the sensor 508. If the user doesn't want the cursor to move, a power down input from the user is sent to the switch module 514 to power down the sensor 508. If the user wants the cursor to move, the switch module 514 receives a power up input to power up the sensor 508. In the embodiment, the switch module 514 is a button that can be pressed to switch between an “ON” state and an “OFF” state.

The control module 516 is used for receiving inputs from the user, and generating input signals. The second processor 518 is used for processing the input signals, and generating control signals. The transmitter 512 is used for transmitting the control signals to the computer 32.

The computer 32 has a receiver 70 corresponding to the transmitter 512 of the remote controller 52. The transmitter 512 communicates with the receiver 70 wirelessly. The receiver 70 is used for receiving the movement signals and the control signals, and components of the computer 32 will process the movement signals and the control signals, and perform corresponding operations to the cursor.

The control module 516 includes a confirmation button 520, a function button 522, and a paging button 524. The confirmation button 520 operates as a left key of a mouse (not shown), and can be pressed by the user to receive a confirmation input and generate confirmation input signals. The second processor 518 processes the confirmation input signals, and generates confirmation control signals to be transmitted by the transmitter 512. The computer 32 will operate confirmation functions, such as operate software program, activate links, and so on.

The function button 522 operates as a right key of the mouse (not shown), and can be pressed by the user to receive a menu input and generate menu input signals. The second processor 518 processes the menu input signals, and generates menu control signals to be transmitted by the transmitter 512. The computer 32 will display a function menu according to the menu control signals.

The paging button 524 operates as the page up and the page down keys of a keyboard (not shown), and can be pressed by the user to receive a paging input and generate paging input signals. The second processor 518 processes the paging input signals, and generates paging control signals to be transmitted by the transmitter 512. The computer 32 will operates paging functions.

As mentioned above, in the remote controller 52, the sensor 508 is used to sense various movements of the remote controller 52, and the remote controller 52 signals the computer 32 to move the cursor according to the sensed signals of the sensor 508. Furthermore, the remote controller 52 also uses a control module 516 to receive inputs from the user to signal the computer 32 to do corresponding operations to the cursor. Therefore, it is convenient to use the remote controller to control the computer 32 to move the cursor, and operate other functions.

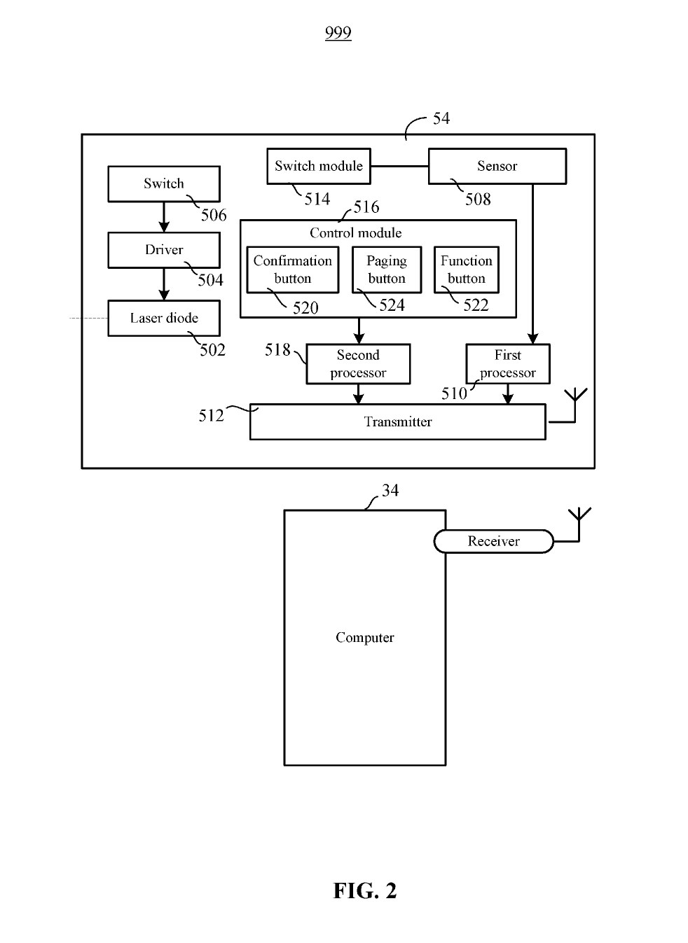

Referring to FIG. 2, a multimedia education system 999 in accordance with a second exemplary embodiment is illustrated. In this embodiment, the multimedia education system 999 includes a computer 34 similar to the computer 32 of the multimedia education system 888, but with a remote controller 54 in accordance with a second exemplary embodiment.

In comparison with the remote controller 52, the remote controller 54 includes a laser diode 502, a driver 504, and a switch 506. The driver 504 is used for driving the laser diode 502 to emit a laser beam, and the switch 506 is used by the user to power up or power down the driver 504. Therefore, the remote controller 54 provides an effective combination function for remote controlling and laser emitting.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A remote controller comprising:
a sensor for sensing movements of the remote controller, and generating corresponding sensed signals;
a first processor for processing the sensed signals and generating movement signals; and
a transmitter for transmitting the movement signals to help a computer to control movements of a cursor thereof.

2. The remote controller according to claim 1, wherein the sensor is an accelerator sensor.

3. The remote controller according to claim 1, wherein the sensor is a gyroscope.

4. The remote controller according to claim 1, further comprising a switch module for powering up or powering down the sensor.

5. The remote controller according to claim 1, further comprising a control module for receiving inputs and generating input signals.

6. The remote controller according to claim 5, further comprising a second processor for processing the input signals, and generating control signals to be transmitted to the computer to control the cursor.

7. The remote controller according to claim 5, wherein the control module comprises a confirmation button, the confirmation button when pressed receives a confirmation input and generate confirmation input signals to be processed by the second processor.

8. The remote controller according to claim 5, wherein the control module comprises a function button, the function button when pressed receives a menu input and generate menu input signals to be processed by the second processor.

9. The remote controller according to claim 5, wherein the control module comprises a paging button, the paging button when pressed receives a paging input and generate paging input signals to be processed by the second processor.

10. The remote controller according to claim 1, further comprising a laser diode for emitting a laser beam.

11. The remote controller according to claim 10, further comprising a driver for driving the laser diode.

12. The remote controller according to claim 11, further comprising a switch for powering up or powering down the driver.

13. A multimedia education system comprising:
a remote controller comprising:
a sensor for sensing movements of the remote controller, and generating corresponding sensed signals;
a first processor for processing the sensed signals and generating movement signals;
a transmitter for transmitting the movement signals; and
a computer for controlling movements of a cursor according to the movement signals received by a receiver of the computer.

14. The multimedia education system according to claim 13, wherein the remote controller comprises a switch module for powering up or powering down the sensor.

15. The multimedia education system according to claim 13, wherein the remote controller comprises a control module for receiving inputs and generating input signals, and a second processor for processing the input signals, and generating control signals to be transmitted to help the computer to control the cursor.

16. The multimedia education system according to claim 13, wherein the remote controller comprises a laser diode for emitting a laser beam, a driver for driving the laser diode, and a switch for powering up or powering down the driver.
